(19) United States
(12) Patent Application Publication
(10) Pub. No.: US 2011/0220314 A1
(43) Pub. Date: Sep. 15, 2011

(54) MOLDING MATERIAL MIXTURE AND FEEDER FOR CASTING ALUMINUM

(75) Inventors: Andre Gerhards, Altlussheim (DE); Udo Skerdi, Bendorf (DE); Josef Kroth, Muhlheim-Karlich (DE); Henning Rehse, Wermelskirchen (DE)

(73) Assignee: ASK CHEMICALS FEEDING SYSTEMS GMBH, Bendorf (DE)

(21) Appl. No.: 13/130,134

(22) PCT Filed: Nov. 16, 2009
(86) PCT No.: PCT/DE09/01602

§ 371 Date: May 19, 2011

(30) Foreign Application Priority Data
Nov. 20, 2008 (DE) 102008058205.0

(51) Int. Cl. B22D 23/00; C09D 5/00

(52) U.S. Cl. 164/135; 106/18.26

(57) ABSTRACT

The invention relates to an exothermic molding material mixture for producing feeders for casting aluminum, comprising at least: - a fireproof base molding material; - a binder; - a proportion of an oxidizable metal of from 5 to 18% by weight relative to the molding material mixture; - an oxidizing agent at a proportion of 10 to 50% by weight relative to the quantity of oxidizing agent required for completely oxidizing the oxidizable metal; and - an igniter for oxidizing the oxidizable metal at a proportion of 15 to 50% by weight relative to the quantity of the oxidizable metal. A feeder made of the exothermic molding material mixture ignites reliably, even at low temperatures, and is characterized by low heat emission. It is therefore particularly suitable for casting aluminum.

The invention relates to an exothermic molding material mixture for producing feeders for casting aluminum, a feeder for casting aluminum produced from the molding material mixture and its use for casting aluminum.

During the production of metal castings in the foundry, liquid metal is filled into the mold cavity of a casting mold. Upon solidification, the volume of the filled-in metal is reduced. For this reason, so-called feeders are regularly employed in or on the casting mold in order to offset the volume deficit during solidification of the casting and prevent a formation of shrink holes in the casting. The feeders are connected to the casting or the threatened casting region and are usually arranged above or on the side of the mold cavity. They comprise a compensation cavity which is connected to the mold cavity of the casting mold and initially accommodates liquid metal. At a later date, at which the metal in the mold cavity solidifies, the liquid metal is again discharged from the compensation cavity in order to offset the volume deficit of the casting.

During the production of metal castings, initially a model is produced which in its shape substantially corresponds to the metal casting to be produced. Supply elements and feeders are attached to this model. Following this, the model is surrounded by molding sand in a molding box. The molding sand is compacted and subsequently hardened. Following the hardening the casting mold is removed from the molding box. The casting mold comprises a mold cavity or, if the casting mold is constructed of a plurality of sections, a part of the mold cavity, which substantially corresponds to a negative shape of the metal casting to be produced. After the casting mold has been assembled if applicable, liquid metal is filled into the mold cavity of the casting mold. In the process, the compensation cavity of the feeder is also filled with liquid metal at least partially. This feeder volume accommodated by the compensation volume of the feeder is available for feeding the casting later on. The inflowing liquid metal displaces the air from the mold cavity or the compensation cavity. The air escapes through openings provided in the casting mold or through porous portions of the casting mold, for example through the wall of a feeder. The feeders therefore preferably have an adequate porosity so that on the one hand the air is displaced from the feeder during the filling-in of the liquid metal and the metal is able to flow into the feeder and on the other hand, upon cooling-down and solidifying of the metal in the mold cavity of the casting mold the still liquid metal from the compensation cavity of the feeder can flow back into the mold cavity of the casting mold without a vacuum being generated in the compensation cavity of the feeder.

In order for the metal to be able to flow from the compensation cavity back into the mold cavity the metal contained in the compensation cavity of the feeder has to solidify at a later date than the metal in the mold cavity of the casting mold.

The heat loss is initially determined by the ratio of surface area of the molding, via which heat can be given off, to its volume. With a given volume the liquid metal will first solidify with the molding that has the larger surface area. The compensation cavity of the feeder or the utilized feeder volume is therefore configured as compact as possible.

In addition, the heat loss is controlled by way of the insulation effect of the material surrounding the liquid metal, that is the material of the casting mold or of the feeder. Feeders therefore preferably consist of a material which has a sufficiently high insulating effect so that the metal in the compensation cavity remains liquid for a sufficiently long period. To this end, the feeder can be produced of a material that has a higher insulating effect than the material of the casting mold, so that the heat loss with the liquid metal contained in the compensation cavity of the feeder is smaller than the heat loss with the metal contained in the mold cavity of the casting mold. Such a material can for example be a fireproof material (=refractory material) containing hollow microspheres of aluminum silicate. Through the gas enclosed in the hollow microspheres such a material has a highly insulating effect. Another possibility of reducing the heat loss of the liquid metal contained in the compensation cavity of the feeder consists in designing the feeder as exothermic feeder. To this end, the feeder is produced from a molding material mixture which, besides the fireproof material and the binder additionally contains a combustible metal, for example aluminum grit, and a suitable oxidizing agent, for example sodium nitrate. Upon contact with the hot liquid metal the mixture ignites and gives off the heat liberated during the oxidation of the metal to the liquid metal contained in the compensation cavity. The compensation cavity or the feeder volume can therefore be selected very small with exothermic feeders.

A suitable feeder must be selected so that the feeder is not sucked empty during the feeding, i.e. the feeder volume is large enough so that at the end of the feeding process adequate liquid metal for feeding is still available. A feeder volume that is too small leads to the formation of so-called primary shrink holes. The feeder however also has to be selected so that the liquid metal of the feeder volume solidifies later than the metal in the mold cavity of the casting mold. If the metal in the compensation cavity solidifies earlier than the metal in the mold cavity, no metal can enter the mold cavity from the compensation cavity, thus the casting can no longer be fed. This leads to the formation of so-called secondary shrink holes.

The solidification of the liquid metal can by approximation be described via the modulus of the casting or of the feeder volume. Modulus means the ratio of volume to heat-emitting surface area. From the module M the solidification time T can be estimated by way of the equation T=K·M². Here, K is a characteristic constant for the casting material used. In first approximation it is therefore true that bodies having the same modulus solidify at the same speed. If the modulus of the body under consideration is doubled, the solidification time is quadrupled.

During the solidification of the metal, liquid metal is sucked from the compensation cavity of the feeder into the mold cavity of the casting mold. Because of this the volume and the surface area of the liquid metal remaining in the compensation volume and thus also its modulus are reduced. If one therefore wants to achieve that the metal in the compensation cavity of the feeder solidifies later than the metal in the mold cavity of the casting mold, the modulus of the feeder remnant remaining in the feeder after the feeding has to be greater than the modulus of the casting or of the region of the casting fed by the feeder.

In the case of natural feeders, i.e. feeders which are designed as a simple cavity in the casting mold, wherein the wall of the compensation cavity is formed by the material of the casting mold, the suction extraction capability of the feeder is approximately 15%. In other words, 15% of the feeder volume originally filled into the compensation cavity is available for the feeding of the casting. The feeder volume can thus become larger than the volume of the casting or the region of the casting fed by the feeder.

When using insulating feeders the modulus with given feeder volume is increased because of the lower heat outflow or, with the modulus predetermined by the casting, the feeder volume can be reduced. In the case of insulating feeders a higher suction extraction capability can therefore be realized compared with natural feeders. The suction extraction capability of insulating feeders is mostly selected in the region of approximately 25% of the feeder volume originally available.

Exothermic feeders with given volume again have a clearly higher modulus since the heat loss of the liquid metal contained in the compensation cavity is offset to a large extent through the exothermia of the feeder. With exothermic feeders a very high suction extraction capability of approximately 65% of the originally available feeder volume can be realized.

In EP 0 888 199 B1 feeders are described that can have exothermic characteristics or insulating characteristics and which are obtained through a cold box method. To this end, a feeder mixture is filled into a feeder casting mold. The feeder mixture comprises an oxidizable metal and an oxidizing agent or an insulating fireproof material or mixtures of these materials as well as an effective binding quantity of a chemically reactive cold box binder. The feeder mixture is molded into an unhardened feeder, which is then brought in contact with a vaporous hardening catalyst. The hardened feeder can then be taken from the casting mold. Hollow microspheres of aluminum silicate can be used as insulating fireproof material. By using such microspheres of aluminum silicate the feeders are imparted a low thermal conductivity and thus a very pronounced insulation effect. Furthermore, these feeders have a very low weight so that on the one hand they are easy to handle and transport and on the other hand they do not fall off the model so easily if the latter is tilted for example.

In EP 0 913 215 B1 a method for producing feeders and other charging and supply elements for casting molds is described. To this end, a composition comprising hollow microspheres of aluminum silicate with an aluminum oxide content of less than 38% by weight, a binder for the cold box hardening and if applicable a filler, wherein the filler is not present in fibrous form, is molded into an unhardened molded product through blowing into a molding box. This unhardened molded product is brought in contact with a suitable catalyst upon which the molded product is hardened. The hardened molded product can then be taken from the molding box. The feeders obtained with this method also have a pronounced insulating effect and a low weight.

From WO 00/73236 A2 an exothermic feeder compound is known that contains aluminum and magnesium, at least one oxidizing agent, an SiO₂-containing filler and an alkali silicate as binder. In addition, the feeder compound contains approximately 2.5 to 20% by weight of a reactive aluminum oxide with a specific surface area of at least approximately 0.5 m²/g and a mean particle diameter (D₅₀) of approximately 0.5 to 8 μm. The feeder compound is practically free of fluorine-containing fluxes. By using such a feeder compound for producing feeders a so-called “hollow combustion” which probably originates from a vitrification of the SiO₂-containing filler with alkali compounds can be significantly suppressed.

In order to be able to prevent a shrink hole formation in the casting during metal casting the exothermic feeder has to reliably ignite upon contact with the liquid hot metal and then burn off in a controlled and even manner. In the meantime, this is being reliably mastered with feeders that were developed for the iron or steel casting. During iron or steel casting temperatures are in a range between 1300 and 1600° C., so that the liquid metal is sufficiently hot to ignite the feeder. In addition, sufficiently high quantities of oxidizable metal and oxidizing agent can be added to the molding material mixture for producing the feeder so that upon contact with the liquid hot metal a reliable ignition of the feeder takes place and the oxidation process is sufficiently intense so that a temperature is achieved at which the metal contained in the compensation cavity of the feeder remains in the liquid state. Usually, such feeders contain between 20 and 33% by weight of oxidizable metal and between 5 and 25% by weight of oxidizing agent based on the weight of the material from which the feeder is produced.

With respect to the casting of aluminum no exothermic feeders have so far been provided which can be reliably employed on an industrial scale. Aluminum is cast at temperatures in the range from approximately 600 to 800° C. If exothermic feeders which were developed for casting iron or steel are used for casting aluminum, these, because of the low temperature of the liquid aluminum, either are not ignited or, if an ignition is achieved, develop extreme heat. There is then the risk that the aluminum starts to boil and gas inclusions or structural defects form in the casting. If however the quantity of oxidizable metal and oxidizing agent in the molding material mixture for producing the feeder is simply reduced in order to diminish the oxidation reaction and thus the heat development, the feeder is no longer reliably ignited or does not evenly and reliably burn off following completed ignition, so that it is not ensured that an adequate quantity of heat is reproducibly provided in order to keep the aluminum contained in the compensation cavity in the liquid state.

Up to now, only natural feeders, that is feeders having no exothermic characteristics and merely delay the solidification of the aluminum in the compensation vessel through their insulating effect are therefore being employed with industrially performed aluminum casting. In order to reliably shift the formation of the shrink hole into the compensation volume of the feeder and in order to ensure that an adequate quantity of liquid aluminum can flow back into the mold cavity of the casting mold, these feeders have to be designed very large. When casting, the liquid aluminum contained in the compensation cavity of the feeder then slowly solidifies from the wall of the compensation cavity in the direction of the centre of the compensation cavity. The point at which a shrink hole is formed through the replenishing flow of the liquid aluminum from the compensation cavity into the mold cavity of the casting mold is hardly controllable. In the most unfavorable case the shrink hole can also form close to or in the connection between compensation cavity and mold cavity, as a result of which the casting becomes useless.

Through the large volume of the compensation cavity arranged in the feeder very large quantities of liquid aluminum have to be filled into the casting mold during casting. Following the casting, a large quantity of aluminum therefore remains in the compensation cavity of the feeder. In the most unfavorable case the volume of the feeder remnant can be larger than the volume of the casting. When casting, the predominant quantity of the liquid aluminum is then used to fill the compensation cavity of the feeder. On removing the casting mold or the feeder, a relatively large feeder remnant remains on the casting which has to be removed and then melted again for reuse. To do so, a relatively large quantity of energy is required.

The invention is therefore based on the object of making available a molding material mixture for producing feeders from which feeders can be produced which more preferably make possible a reliable feeding of a casting for casting aluminum.

This object is solved through a molding material mixture for producing feeders for casting aluminum with the features of Patent claim 1. Advantageous embodiments of the molding material mixture according to the invention are the subject of the dependent claims.

Surprisingly it was found that through the addition and careful adjustment of the quantity of an ignition agent for the oxidation of the oxidizable metal and a disproportionate reduction of the quantity of the oxidizing agent the quantity of oxidizable metal can be lowered so far that following ignition of the feeder the oxidation of the oxidizable metal and thus the heat development can be controllably conducted at a very low level, while controlled ignition of the feeder and controlled burning off is nevertheless achieved. Because of this, the feeder reaches a maximum temperature that can be kept below 1250° C., preferably below 1150° C., more preferably below 1050° C. With such a temperature there is no need to fear that aluminum is heated above its boiling point and thus gas inclusions and structural defects are caused in the casting. The temperature in the interior of the feeder can for example be determined with a thermocouple, which is placed in the centre of the compensation cavity of the feeder. If the feeder is ignited in air, slightly higher temperatures are obtained compared to a feeder which is integrated in a casting mold, i.e. surrounded by sand. The inventors assume that this is due to the improved air access. The measured temperature upon burning off in air is approximately 50 to 100% higher than with a feeder that is integrated in a casting mold. However, even when burning off in air, the measured maximum temperature remains in the stated range.

The oxidation of the metal through the sub-stoichiometric quantity of the oxidizing agent added resembles more a glowing than a burning. Nevertheless, the feeder can be reproducibly ignited and the oxidation of the feeder runs evenly through the body of the feeder without the oxidation being prematurely extinguished or individual local temperature maxima forming within the feeder body.

The use of an igniter results in an activation of the oxidizable metal. The oxidizable metal is passivated through a thin oxide layer which forms on the surface. Through the igniter, the oxide layer can for example be etched at least partially and thus destroyed, so that the bright metal is exposed on the surface. This bright metal can be very easily oxidized so that the oxidation of the oxidizable metal starts and the feeder ignites. However, a material which very easily ignites under the conditions of metal casting and in the process gives off heat through which in turn the oxidizable metal can be ignited can also be used as igniter. Here, the igniter initially ignites itself and as a consequence initiates the oxidation of the oxidizable metal.

Through the even heat generation of the feeder at a relatively low temperature level suitable for casting aluminum, the aluminum in the compensation cavity of the feeder can be kept in a liquid state for a long time. For this reason, the aluminum can flow back from the compensation cavity of the feeder into the mold cavity of the casting mold while the aluminum in the mold cavity solidifies. Because of this, the formation of the shrink hole upon solidification of the aluminum in the compensation cavity takes place in a controlled manner at a location that is removed from the connection between compensation cavity and mold cavity, so that casting defects can be reliably prevented. Through the exothermia of the oxidation and the resultant possibility of keeping the aluminum in the compensation cavity in a liquid state the feeder or the compensation cavity can be significantly reduced compared with the natural feeders usual up to now. The feeder remnant remaining on the casting after casting therefore is substantially smaller, which is why the amount of energy that is required upon reuse for melting of the feeder remnant is smaller than with the previously usual methods.

According to the invention, an exothermic molding material mixture for producing feeders for casting aluminum is therefore made available which contains at least:
a fireproof base molding material;
a binder;
based on the molding material mixture a proportion of an oxidizable metal of 5 to 18% by weight;
an oxidizing agent in a proportion from 10 to 50% based on the quantity of the oxidizing agent required for the complete oxidization of the oxidizable metal, and
an igniter for the oxidation of the oxidizable metal in a proportion from 1 to 50% by weight based on the quantity of the oxidizable metal.

For producing the molding material mixture according to the invention materials are used per se as are already known for producing feeders. The materials however are employed in a proportion matched in a special manner so that the oxidation or heat development can be controlled and consistently kept at a very low level.

Thus, the molding material mixture initially comprises a fireproof base molding material. The fireproof base molding material has a melting point which is significantly above the temperature which a feeder produced from the molding material mixture according to the invention reaches following the ignition. Preferentially, the melting point of the fireproof base molding material preferably is at least 200° C., preferably at least 500° C. above the maximum temperature of the feeder. Preferably, the fireproof base molding material has a melting point of at least 1300° C., preferably at least 1500° C. According to an embodiment, a fireproof base molding material is used, which has a melting point of less than 3000° C., according to a further embodiment of less than 2700° C. Suitable fireproof base molding materials are for example quartz, aluminum silicates or zirconium oxide sand. In addition, synthetically produced fireproof fillers such as mullite (Al₂SiO₅). In the choice of the fireproof base molding material there are initially no restrictions. The fireproof base molding material should have an adequate particle size so that a feeder produced from the base molding material has a sufficiently high porosity in order to make possible escaping of volatile compounds during the casting process. Preferably, at least 70% by weight, more preferably at least 80% by weight of the fireproof base molding material have a particle size ≧100 μm. The average particle size D₅₀ of the fireproof base molding material should preferentially be between 100 and 350 μm. The particle size can for example be determined through sieving analysis.

The proportion of the fireproof base molding material in the molding material mixture is preferentially selected in the range from 10 to 75% by weight, preferably 40 to 70% by weight.

In addition, the molding material mixture according to the invention comprises a binder with which the molding material mixture following the molding can be solidified in that a strong adhesion between the grains of the fireproof base molding material is established. The quantity of the binder is selected sufficiently large in order to be able to guarantee an adequate dimensional stability of a feeder produced from the molding material mixture. Basically, all binders which are usual in the production of feeders can be used.

Thus, both organic as well as inorganic binders can be used in the molding material mixture according to the invention, the hardening of which can be effected through cold or hot methods. In this case, cold methods means methods which can be substantially carried out at room temperature without heating of the molding material mixture. Hardening is mostly effected through a chemical reaction which can for example be triggered in that a gaseous catalyst is conducted through the molding material mixture to be hardened or in that a liquid catalyst is added to the molding material mixture. With the hot method, the molding material mixture is heated to a sufficiently high temperature after shaping in order to expel for example the solvent contained in the binder or in order to initiate a chemical reaction through which the binder is hardened through cross-linking.

When using a cold box binder, that is a binder which is hardened through cold methods by adding a catalyst, this is preferably selected from the group of phenolic urethane resins, which are activated through amines, epoxy acrylic resins, which can be activated through SO₂, alkaline phenolic resins which can be activated through CO₂ or methyl formate, as well as water glass, which can be activated through CO₂. Such cold box binders are known to the person skilled in the art. Such binder systems are described for example in U.S. Pat. No. 3,409,579 or U.S. Pat. No. 4,526,219. However, other binders can also be used, for example dextrin, sulfite waste lye or salt binders.

Binders on polyurethane basis are generally composed of two components, wherein a first component contains a phenolic resin and a second component a polyisocyanate.

These two components are mixed with the fireproof base molding material and the molding material mixture shaped through ramming, blowing, shooting or another method compacted and subsequently hardened. Depending on the method with which the catalyst is introduced into the molding material mixture one differentiates between the “polyurethane no-bake method” and the “polyurethane cold box method”.

With the polyurethane no-bake method a liquid catalyst, generally a liquid tertiary amine is introduced into the molding material mixture before it is put in a mold and hardened. For producing the molding material mixture, phenolic resin, polyisocyanate and hardening catalyst are mixed with the fireproof base molding material. Here, the procedure can for example be that the fireproof base molding material is initially encased with a component of the binder and then the other component added. The hardening catalyst is added to one of the components. The ready prepared molding material mixture has to have an adequately long processing time so that the molding material mixture can be plastically deformed sufficiently long and processed into a feeder. The polymerization to this end has to take place correspondingly slowly so that hardening of the molding material mixture does not already occur in the storage vessels or feed lines. On the other hand, hardening must not take place too slowly in order to achieve a sufficiently high throughput during the production of feeders. The processing time can for example be influenced by adding retarders, which slow down the hardening of the molding material mixture. A suitable retarder is for example phosphoric oxide chloride.

With the polyurethane cold box method the molding material mixture produced from fireproof base molding material, polyol component, polyisocyanate component and additives if applicable is initially put into a mold without catalyst. A gaseous tertiary amine, which if applicable can be blended with an inert carrier gas, is subsequently conducted through the molding material mixture molded into a feeder. On contact with the gaseous catalyst, the binder hardens very rapidly so that a high throughput during the production of feeders is achieved.

Preferably, inorganic binders are used in the molding material mixture according to the invention.

According to a preferred embodiment water glass is used as binder in the exothermic molding material mixture. The use of water glass as binder has the advantage that when burning off the feeder, a lower smoke development occurs than when using organic binders. This lowers the exposure to harmful compounds which are liberated during casting as well as the exposure to odors. As water glass, usual water glasses can be used such as are already used as binder in molding material mixtures for the foundry industry. These water glasses contain dissolved sodium or potassium silicates and can be produced by dissolving glass-like potassium and sodium silicates in water. The water glass preferentially comprises a modulus M₂O/SiO₂ in the range from 2.0 to 3.5, wherein M stands for sodium and/or potassium. The water glasses preferentially have a solid proportion in the range from 20 to 55% by weight. In addition, solid water glass can also be used for producing the feeders. For the proportions in the molding mass for the production of the feeder, only the solid proportions of the water glass are taken into account in each case.

The proportion of the binder calculated in the dry state, that is without consideration of solvents for diluting the binder and based on the dry molding material mixture is preferably selected between 5 and 50% by weight, particularly preferably between 8 and 40% by weight and more preferably preferred in the range from 10 to 20% by weight.

As further proportion, the molding material mixture according to the invention comprises an oxidizable metal. Here, too, all oxidizable metals as have already been used in the past for producing exothermic feeders can be employed. The metals should have sufficient reactivity to a reaction with an oxidizing agent so that the feeder on contact with liquid aluminum can be reliably ignited.

According to the invention, the proportion of oxidizable metal in the molding material mixture is kept relatively low so that compared with feeders for casting iron and steel only a relatively low heat development takes place and a feeder produced from the molding material mixture is heated only up to a temperature of preferably less than 1250° C. The proportion of the oxidizable metal in the molding material mixture merely amounts to 5 to 18% by weight, preferentially 8 to 15% by weight, preferably 9 to 14% by weight based on the weight of the molding material mixture. Compared with feeders for casting iron and steel this is very low. Such feeders for casting iron and steel have a content of oxidizable metal in the range from 20 to 33% by weight. The percentage details relate to the molding material mixture without proportions of solvents, which are introduced into the molding material mixture for example via the solvent of the binder.

In addition, the molding material mixture contains an oxidizing agent with which the oxidizable metal after ignition of the feeder is oxidized. As oxidizing agent, iron oxide and/or an alkali nitrate such as sodium or potassium nitrate can be used.

In the molding material mixture the oxidizing agent is used highly sub-stoichiometrically. As a result, the oxidation of the oxidizable metal is greatly slowed down since air oxygen has to be additionally transported to the oxidizable metal in order to have the oxidation progress completely. The heat development that occurs during the oxidation is therefore further suppressed. The proportion of the oxidizing agent based on the quantity of the oxidizing agent for the complete oxidation of the oxidizable metal is selected in a range from 10 to 50%, preferentially 15 to 35%, more preferably 20 to 30%.

Based on the weight of the molding material mixture the proportion is dependent on the oxidizing agent used. Preferably, the proportion of the oxidizing agent in the molding material mixture is selected in the range from 3 to 20% by weight, preferentially 5 to 18% by weight, particularly preferably 7 to 15% by weight.

Furthermore, the molding material mixture according to the invention contains an igniter for the oxidation of the oxidizable metal. During the development of the molding material mixture according to the invention the inventors started out from the idea that the grains of the oxidizable metal are passivated through a thin oxide layer. Therefore, any material is suitable as igniter which can overcome the passivation to which the oxidizable metal is subjected through the oxide layer formed on its surface. The igniter thus brings about a breaching of the passivating oxide layer so that the bright oxidizable metal is exposed. To this end, the igniter can react with the thin oxide layer wherein the latter is for example reduced or converted into a compound that does not cause a continuous passivation of the oxidizable metal or which is better permeable to the oxidizing agent. Thus, the passivation layer present on the oxidizable metal can be initially etched by such an igniter. Such an igniter can for example be a halogen such as bromine or iodine, which reacts with the passivating layer of the oxidizable metal for example aluminum. The igniter however can also be a material that is more easily oxidized than the oxidizable metal and during the oxidation exhibits a sufficiently high heat development so that the oxidizable metal is melted at least in portions, as a result of which the passivating layer can be torn open.

Based on the quantity of the oxidizable metal employed the igniter is used in a proportion from 15 to 30% by weight, preferentially 25 to 40% by weight, preferably 30 to 35% by weight.

Based on the weight of the molding material mixture the proportion of the igniter is preferably selected greater than 1% by weight, preferentially greater than 2% by weight, particularly preferably greater than 3% by weight and according to a further embodiment greater than 4% by weight. In order to achieve activation of the oxidizable metal it is sufficient according to an embodiment if the proportion of the igniter is selected smaller than 15% by weight, preferentially smaller than 12% by weight, preferably smaller than 9% by weight.

Through the special composition of the molding material mixture according to the invention, feeders can be produced which after the ignition reproducibly create a temperature profile which has a maximum temperature of preferably less than 1250° C., further preferably less than 1150° C., wherein burning-off takes place evenly and in a controlled manner. On the other hand, the feeder upon burning-off reaches a temperature of preferentially more than 600° C., preferably more than 700° C. so that the aluminum in the feeder cavity is kept in the liquid state until the aluminum in the mold cavity of an associated casting mold has solidified. The aluminum contained in the compensation cavity of a feeder produced from the molding material mixture according to the invention can be reliably kept in a liquid state so that feeding of the casting takes place under controlled and reproducible conditions. From the molding material mixture feeders can therefore be produced which with given feeder volume have a higher modulus than natural feeders or insulating feeders, or which with predetermined modulus have a smaller feeder volume.

According to a first embodiment the igniter for the oxidation of the oxidizable metal is an etching agent that can initially etch the passivated surface of the oxidizable metal. An etching agent in this case means a compound that can react with the passivating layer of the oxidizable metal, generally an oxide film, so that the passivating layer is breached and the reactivity or ignitability of the oxidizable metal is increased.

Preferably, a fluorine-containing flux agent is used as igniter. The proportion of the fluorine-containing flux agent is calculated as sodium hexafluoroaluminate.

Generally, all fluorine-containing flux agents can be employed which are used during the production of exothermic feeders. Suitable fluorine-containing flux agents are for example sodium hexafluoroaluminate, potassium hexafluoroaluminate, sodium fluoride and potassium fluoride. Through the high proportion of the fluorine-containing flux agents a low ignition temperature and an even burn-off of the exothermic molding material mixture according to the invention is achieved.

According to a second embodiment magnesium is used as igniter. Magnesium metal can be ignited relatively easily and exhibits a high heat development during the oxidation.

The proportion of the magnesium in the exothermic molding material mixture based on the molding material mixture is preferably at least 3% by weight, particularly preferably at least 5% by weight. With too low a proportion of the magnesium the influence on the ignitability of the mixture is only low. The magnesium metal can be employed in any form. Preferably the magnesium is employed in the form of a fine grit since this can be distributed highly homogenously in the molding material mixture.

The magnesium metal can be employed in the pure form. However, it is also possible to use the magnesium in form of an alloy, for example in the form of an alloy with the oxidizable metal, for example an aluminum-magnesium alloy. Through the fine distribution of the magnesium in the alloy the ignition temperature of the alloy can be lowered so that a controlled ignition of the molding material mixture or of the feeder produced from the molding material mixture is achieved upon the inflow of the liquid aluminum in the compensation cavity of the feeder. The proportion of the magnesium in the alloy is preferably selected greater than 30% by weight, preferably greater than 40% by weight, particularly preferably in the range from 50 to 80% by weight.

The oxidizable metal used in the molding material mixture according to the invention is preferably selected from the group of aluminum, magnesium and silicon and their alloys. The mentioned metals or alloys can each be employed by themselves or as mixture.

According to an embodiment both the oxidizable metal as well as the igniter can be formed by magnesium. Since magnesium however is accessible with more difficulty than for example aluminum, aluminum is preferably selected as oxidizable metal. Magnesium is preferably employed as igniter and less preferably as oxidizable metal.

The oxidizable metal should preferably be present homogenously distributed in the exothermic molding material mixture so that following the ignition uniform heating of the feeder takes place. The oxidizable metal is therefore preferably worked into the molding material mixture in the form of a powder or fine granulate or grit. However, the oxidizable metal should not be present in too finely a distributed form since otherwise the metal particles can be subjected to too great a reactivity and the oxidation of the oxidizable metal progresses too quickly. Preferably, the grain size of the oxidizable metal is selected greater than 0.05 μm, particularly preferably greater than 0.1 μm. On the other hand, the grain size should preferably not be selected too large since uniform heat development of the feeder across the casting process is then no longer ensured. Preferably, the grain size of the oxidizable metal is selected smaller than 1 mm, preferentially smaller than 0.8 mm, particularly preferably smaller than 0.5 mm. The grain size of the oxidizable metal can be determined with the usual means, for example by means of sieving analysis.

Insofar as magnesium is employed as igniter the grain size of the magnesium grit is selected in ranges as stated above for the oxidizable metal.

In order to keep the heat loss of the feeder or the liquid aluminum contained in the compensation cavity as low as possible, the feeder is preferably embodied so that the molding material mixture has a heat-insulating effect. To this end, the fireproof base molding material according to an embodiment is at least partially formed from an insulating fireproof material. An insulating fireproof material means a fireproof base molding material which has a poorer heat conductivity than quartz sand. Suitable insulating fireproof materials are for example pumice, hollow glass spheres, fireclay, light spheres, mica, clays, flyash, foamed materials, open-pored ceramic and comparable materials. Particularly preferably insulating fireproof materials are employed in the exothermic molding material mixture according to the invention, which have a low heat conductivity. Preferentially the heat conductivity number of the insulating fireproof material amounts to 0.04-0.25 W/mK, preferably 0.07-0.2 W/mK. The heat conductivity number can be determined with usual devices for example a TCT 426 heat conductivity tester according to the T(R)-method in accordance with ASTM-C-1113.

The fireproof base molding material of the exothermic molding material mixture according to the invention therefore preferably comprises at least one proportion of an insulating fireproof material which has cavities and through which the gas enclosed in the cavities is highly heat-insulating. According to an embodiment the exothermic molding material mixture as insulating fireproof material comprises a proportion of fireproof hollow microspheres. These hollow microspheres have a continuous outer envelope which encloses a gas-filled cavity. The envelope is preferably constructed of an aluminum silicate. The hollow microspheres have a diameter of preferentially less than 3 mm, particularly preferably less than 1 mm. The wall thickness of the hollow microspheres is preferentially 5 to 20% of the diameter of the hollow microspheres. Such microspheres can for example be won from flyash which in industrial plants is separated from combustion waste gases. The composition of the hollow aluminum silicate microspheres can vary within wide ranges. Preferably the aluminum proportion, calculated as Al₂O₃ and based on the weight of the hollow microspheres, is between 20 and 75%, preferentially 25 and 40%. The proportion of the hollow microspheres in the fireproof base molding material is preferentially selected greater than 30%, preferably greater than 40%, particularly preferably in the range from 60 to 95%, more preferably preferred in the range from 65 to 90% by weight. Hollow glass spheres with an aluminum content from 0 to 25% can also be used.

According to a further preferred embodiment the molding material mixture according to the invention comprises as insulating fireproof material at least proportionately a porous fireproof material with an open-pored structure. Through the open-pored structure the feeder is given a very good gas permeability so that the air in the compensation cavity upon the entering of the liquid aluminum can escape largely unhindered or, when the liquid aluminum during feeding flows out of the compensation cavity again, can again flow back into the compensation cavity largely unhindered.

A porous fireproof material having a continuously open pore structure is to mean a fireproof material with a sponge-like structure which extends throughout the volume of the grain. Such an open-pored structure can for example be identified on a polished sample image of a grain, if applicable under microscopic magnification. While with the abovementioned hollow microspheres a single “pore” in each case is surrounded by a largely gas-tight envelope and no simple gas exchange between the cavity of the hollow microsphere and the surroundings is possible, the open-pored porous fireproof material is traversed by passages that make possible a gas exchange of the individual pores with the surroundings. The proportion of the pores in the total volume of the porous open-pored material is preferentially very high. Preferably, the porous fireproof material has a pore volume of at least 50%, preferentially of at least 60%, more preferably at least 65% based on the total volume of the porous fireproof material. The pore volume can for example be determined through mercury intrusion.

Suitable porous fireproof materials are for example pumice, expanded slate, pearlite, vermiculite, boiler sand, foam lava, porous glass spheres or gas concrete as well as their mixtures.

The porous fireproof materials with open-pored structure contained in the exothermic molding material mixture according to the invention in accordance with an embodiment preferentially have a density of less than 0.5 g/ml, preferentially less than 0.4 g/ml, particularly preferably 0.05 to 0.4 g/ml. Density in this regard means the bulk density. The feeders produced from the exothermic molding material mixture according to the invention, which comprise a proportion of an insulating fireproof material, therefore advantageously have a low weight. The feeders can for example be fitted onto a model and because of their low weight do not fall off when the model or the mold is turned.

The fireproof base molding material can be completely or partially formed from the insulating fireproof material. All exemplary less insulating fireproof base molding materials have already been mentioned. An example for a suitable fireproof base molding material that can be mixed with the insulating fireproof material is quartz sand. Preferentially, the proportion of the insulating fireproof material in the fireproof base molding material is selected greater than 20% by weight, preferably greater than 30% by weight, more preferably greater than 40% by weight. An adequate insulating effect is already achieved when the proportion of the insulating fireproof material in the fireproof base molding material is preferentially selected smaller than 80% by weight, preferably smaller than 70% by weight, particularly preferably smaller than 60% by weight.

The exothermic molding material mixture according to the invention preferentially has a gas permeability number of at least 150, preferentially more than 200, more preferably more than 300. The gas permeability number is a characteristic quantity usual in the foundry industry for the porosity of moldings or molding sands. It is determined on a test body having a defined shape using equipment by the Georg Fischer AG Company, Schaffhausen, Switzerland. Determination of the gas permeability is described with the examples.

According to an embodiment, pumice is used as porous fireproof material with open-pored structure. Pumice is a naturally occurring tektite, i.e. it substantially has an amorphous structure without detectable crystals. Pumice has a low specific weight of up to approximately 0.3 g/cm³. It has a very high pore volume of up to 85%. Through its high porosity the pumice has a very high gas permeability.

As pumice, a material from a natural source is preferentially used which is ground to a suitable grain size. The grain size of the ground pumice preferentially amounts to less than 1.5 mm, particularly preferably less than 1 mm. The grain size can for example be adjusted through sieving or air classification.

A further suitable insulating fireproof material are porous glass spheres. The grain size preferentially amounts to 0.1 to 1 mm. The bulk density preferentially is in the range from 200 to 500 kg/m³.

In addition to the fireproof base molding material the exothermic molding material mixture according to the invention according to an embodiment can contain a proportion of a reactive aluminum oxide. The reactive aluminum oxide preferably has the following properties:

| | |
|---|---|
| Al₂O₃-content | >90% |
| Content of OH-groups | <5% |
| Specific surface area (BET) | 1 to 10 m²/g |
| Mean particle diameter (D₅₀) | 0.5 to 15 μm |

Through the addition of a reactive aluminum oxide to the molding material mixture the strength of a feeder produced from the molding material mixture can be improved.

The reactive aluminum oxide based on the weight of the exothermic molding material mixture is preferentially present in the molding material mixture according to the invention in a proportion of more than 2% by weight, preferentially more than 5% by weight.

If the fireproof base molding material is proportionally formed from an insulating fireproof material the exothermic molding material mixture can still comprise a fireproof filler which preferentially has a relatively low SiO₂-content. Preferentially, the fireproof filler has a SiO₂-content of less than 60% by weight, preferably less than 50% by weight, particularly preferably less than 40% by weight. Through the low proportion of SiO₂ the risk of vitrification is counteracted, as a result of which casting defects can be avoided. According to an embodiment the exothermic molding material mixture according to the invention does not contain any SiO₂ as mixture constituent, in other words is free for example of quartz sand. The SiO₂-content contained in the molding material mixture is thus preferentially present in bonded form as aluminum silicate.

Particularly preferably the fireproof filler is at least proportionally formed from fireclay. Fireclay is a highly baked (double baked) clay having a dimensional stability up to a temperature of approximately 1500° C. In addition to amorphous proportions fireclay can contain the crystalline stages mullite (3Al₂O₃.2SiO₂) and cristobalite (SiO₂). The fireclay is likewise preferably ground to a grain size of less than 1.5 mm, preferentially less than 1 mm. Through the fireclay the feeders produced from the exothermic molding material mixture according to the invention are given a very high temperature resistance and strength.

Preferably the proportion of the fireclay in the fireproof filler is selected high. Preferably, the proportion of the fireclay based on the weight of the fireproof filler is at least 50% by weight, more preferably preferred at least 60% by weight and very particularly preferred at least 70% by weight. In a particularly preferred embodiment the fireproof filler is substantially formed only from fireclay. The fireclay is preferably contained in the exothermic molding material mixture in ground form. The grain size in this case amounts to preferably less than 1.5 mm, particularly preferably less than 1 mm.

The fireclay preferably has a high proportion of aluminum oxide. Preferably the clay contains at least 30% by weight of aluminum oxide, more preferably preferred at least 35% by weight and very particularly preferably at least 40% by weight. The aluminum oxide is preferably present in the form of aluminum silicates.

The proportion of the fireproof filler based on the weight of the exothermic molding material mixture is preferably between 5 and 60% by weight, particularly preferably 8 to 50% by weight. The proportions of the fireproof filler do not include the proportions of pumice and reactive aluminum oxide.

Besides the already mentioned constituents the molding material mixture according to the invention can still contain other constituents in usual quantities. Thus, an organic material can be included for example such as wood flour. Advantageously, the organic material is present in a form in which it does not absorb any liquid constituents such as water glass for example. During the production of the exothermic molding material mixture the wood flour can be initially sealed with a suitable material such as water glass for this purpose, so that the pores are closed. Through the presence of the organic material the cooling down of the liquid aluminum upon initial contact with the wall of the compensation cavity is further lowered.

Insofar as an organic material such as wood flour is contained in the exothermic molding material mixture, such is contained in a proportion from 5 to 20% by weight, preferably 8 to 12% by weight based on the exothermic molding material mixture.

A feeder, that has been produced from the exothermic molding material mixture described above, is specifically suitable for casting aluminum, since after the ignition it only exhibits a relatively low heat development and consequently does not heat the liquid aluminum arranged in a compensation cavity of such a feeder to a high temperature, so that boiling of the aluminum is prevented. Because of this, gas inclusions in the casting as well as folds in the crystal structure of the casting are effectively suppressed.

Consequently the invention relates also to a feeder for casting aluminum produced from an exothermic molding material mixture such as was described above. The feeder upon burn-off reaches a temperature of less than 1250° C., preferably less than 1150° C., preferentially less than 1050° C. In order to keep the aluminum present in the compensation cavity of the feeder in the liquid state for a sufficient period of time the feeder upon burn-off preferentially reaches a temperature of more than 600° C., preferably more than 700° C.

The exothermic feeder for the casting of aluminum according to the invention comprises a compensation cavity and a feeder wall surrounding the compensation cavity, wherein the feeder wall is constructed of a material containing at least:
a fireproof base molding material;
a binder;
an oxidizable metal in a proportion of 5 to 18% by weight based on the weight of the feeder wall;
an oxidizing agent in a proportion based on the quantity of the oxidizing agent required for the complete oxidation of the oxidizable metal from 10 to 50%; and
an igniter for the oxidation of the oxidizable metal in a proportion based on the quantity of the oxidizable metal of 15 to 50%.

The exothermic feeder for the casting of aluminum according to the invention can in principle assume any known form for feeders. Thus, the term “feeder” as is used here for example also comprises feeder sleeves, i.e. approximately cylindrical tubes which are open on both sides, caps, that is approximately cylindrical tubes which are closed on one side and also feeders in the popular sense. The feeders can be insertable into a casting mold or also molded into the casting mold. A feeder in terms of the invention thus means a molding with a feeder wall which encloses a compensation cavity, wherein the compensation cavity can be open on one or on two sides. The compensation cavity during the casting of metal accommodates liquid metal and during the solidification of the casting partially releases said liquid metal again. A residual feeder means the solidified metal which after the casting process remains and solidifies in the compensation cavity of the feeder and is connected to the casting.

The individual constituents as well as advantageous embodiments of the feeder have already been explained with the description of the exothermic molding material mixture according to the invention. Reference is made to the corresponding passages of the description.

The exothermic feeder for casting aluminum according to the invention can in principle assume any form such as is known for casting metal, for example casting of iron or steel. The feeder can be embodied in one or multiple parts, while the entire feeder can have been produced from the exothermic molding material mixture according to the invention, or merely parts of the feeder. Thus the feeder can comprise a feeder head that is produced from the exothermic molding material mixture, while a displaceable sleeve can have been inserted in the feeder head which establishes the connection between a compensation cavity contained in the feeder head and the mold cavity of the casting mold. The feeder can be designed in a form so that it can be directly placed onto a model. However, it is also possible to provide a receptacle for a spring mandrel onto which the feeder according to the invention is then fitted.

In contrast with the feeders previously used in casting aluminum the exothermic feeder according to the invention can be embodied substantially smaller. Thus, a compensation cavity in the interior of the feeder can be embodied relatively small since the quantity of aluminum accommodated within it is kept in the liquid state during the casting through the exothermic properties of the feeder.

In principle, the feeder according to the invention can be embodied in any size and with any wall thickness. The dimensional details mentioned in the following are therefore exemplary.

The volume of the compensation cavity is selected as a function of the size of the casting to be produced and the shrinkage to which the casting is subjected during the solidification of the aluminum. According to an embodiment the outer volume of the feeder, that is the volume which is delimited through the outer wall of the feeder or in the case of multi-part embodiment of the feeder head is less than 3000 cm³, according to a further embodiment less than 2500 cm³, and according to a further embodiment less than 1000 cm³. However, feeders according to the invention having an outer volume of more than 3000 cm³ can also be provided. According to an embodiment the outer volume of the feeder is selected greater than 250 cm³.

The maximum wall thickness of the feeder according to the invention according to an embodiment amounts to less than 15 cm, according to a further embodiment less than 8 cm, and according to a further embodiment less than 4 cm. However, it is also possible to provide feeders according to the invention which have a maximum wall thickness amounting to more than 15 cm. According to an embodiment the maximum wall thickness is selected greater than 0.5 cm, according to a further embodiment greater than lcm. The maximum wall thickness corresponds to the thickest point of the feeder wall surrounding the compensation cavity, wherein in each case the shortest distance between outer and inner wall is measured.

The choice of the size of the feeder and its dimensions is greatly dependent on the casting under consideration. However, based on his special knowledge, if applicable with the inclusion of preliminary tests, the person skilled in the art is able to select a suitably dimensioned feeder.

In comparison with natural feeders, that is feeders which are merely produced from a usual fireproof base molding material such as quartz sand, the quantity of the aluminum which for feeding the casting is accommodated in the compensation cavity of the feeder can be reduced by up to 80%.

The feeder according to the invention is produced in principle according to usual methods. Initially, the exothermic molding material mixture described above is produced. This exothermic molding material mixture is worked into a blank in that the exothermic molding material mixture for example is shot into a suitable shape in a core shooter by means of compressed air. Preferred fireproof base molding materials and additional constituents of the exothermic molding material mixture were already described in connection with the description of the exothermic molding material mixture according to the invention. Suitable binders have also been explained already in the description of the exothermic molding material mixture. Particularly preferably, water glass is used as binder.

If during the production of the feeder water glass is used as binder the hardening of the exothermic molding material mixture takes place through usual methods. The hardening can take place by conducting carbon dioxide through the blank of the feeder, wherein the hardening preferably takes place at room temperature. However, it is also possible to heat the blank of the feeder for example to temperatures from 120 to 200° C. In order to accelerate hardening, hot air can also be directed through the blank of the feeder. The temperature of the blown-in air preferentially amounts to 100° C. to 180° C., particularly preferably 120° C. to 150° C. After the first hardening, the feeder can be additionally dried for example in an oven or through exposure to microwave radiation.

If other binders, for example organic binders, are used the hardening of the exothermic molding material mixture after the shaping of the feeder is likewise effected through popular methods. Thus, when using a cold-box binder, a gaseous tertiary amine can for example be directed through the exothermic molding material mixture molded into a feeder.

After the hardening, the feeder can be removed from the molding tool. Hardening can be complete or have only occurred partially so that following the removal post-hardening for example through the effect of heat is carried out.

The feeder according to the invention is suitable for casting aluminum. The invention therefore additionally relates to the usage of the feeder described above for casting aluminum. There, the feeder is attached to the casting mold or introduced in the latter in the usual manner. After completion of the casting mold the casting of aluminum is carried out in the usual manner.

Preferably, the exothermic feeder according to the invention is used for casting aluminum in the manner that initially a casting mold with a mold cavity is provided. The casting mold comprises at least one feeder as it has been described above and which comprises a compensation cavity.

Following this, liquid aluminum is filled into the casting mold so that at least the mold cavity of the casting mold as well as a feeder volume of the feeder are filled with the liquid aluminum. The feeder volume maximally corresponds to the volume of the compensation cavity of the feeder and corresponds to the quantity of aluminum that is provided in the compensation cavity at the start of feeding. Mostly the feeder volume is selected smaller than the volume of the compensation cavity, preferentially smaller than 95%, preferably smaller than 90% of the volume of the compensation cavity. Preferably, at least 50% of the volume of the compensation cavity is used as feeder volume.

The feeder is ignited through the liquid aluminum flowing into the compensation cavity of the feeder.

The liquid aluminum is left to solidify, wherein the aluminum initially solidifies in the mold cavity of the casting mold. In the process, to compensate for the shrinkage that occurs during solidification, liquid aluminum is sucked from the compensation cavity of the feeder into the mold cavity of the casting mold.

Through the exothermic properties of the feeder the latter has a high modulus or the volume of the compensation cavity can be selected relatively small, wherein a large proportion of the feeder volume can be utilized for feeding. With the usage of the feeder according to the invention preferentially at least 25%, preferably at least 30%, particularly preferably at least 40%, more preferably preferred at least 50% of the feeder volume are utilized for feeding the casting, that is the corresponding quantity of liquid aluminum transferred from the compensation cavity of the feeder into the mold cavity of the casting mold. Mostly, the entire volume of the compensation cavity cannot be utilized for feeding so that a residual feeder remains on the casting. According to an embodiment, less than 90% of the feeder volume is utilized for feeding.

In the following, the invention is explained in more detail by means of examples and the enclosed Figures. There it shows:

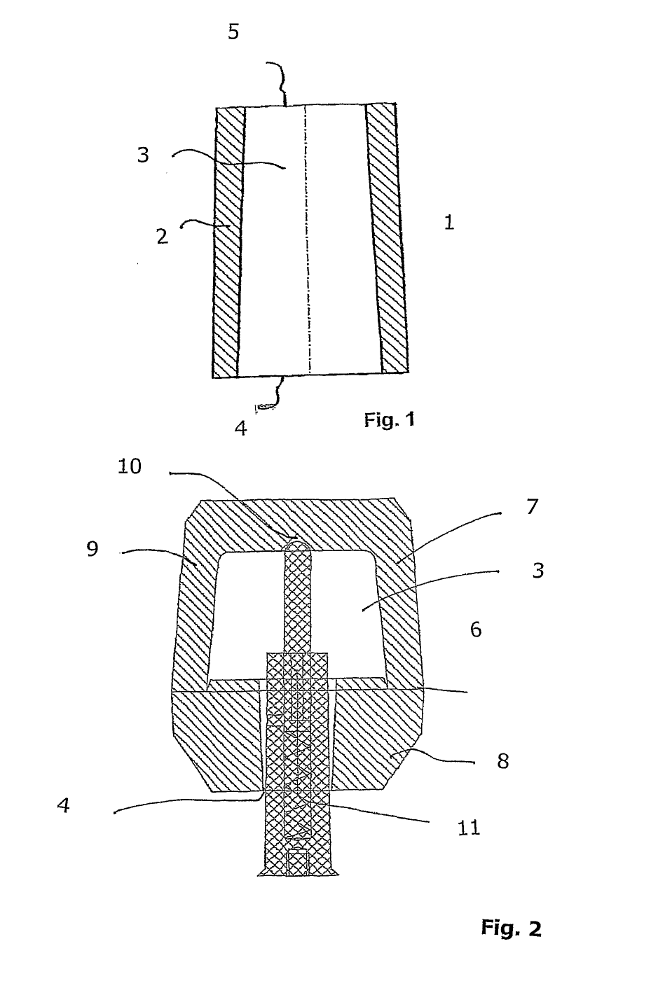

FIG. 1: a longitudinal section through a feeder according to the invention;

FIG. 2: a longitudinal section through a further embodiment of the feeder according to the invention.

FIG. 1 shows a longitudinal section through a feeder according to the invention. The feeder 1 has a tubular shape. The feeder wall 2 is constructed from a fireproof molding material mixture which is characterized by a very small proportion of an oxidizable metal, a—compared with the quantity of the oxidizable metal—sub-stoichiometrically selected proportion of oxidizing agent and by a comparatively high proportion of a fluorine-containing flux agent. The feeder wall 2 surrounds a compensation cavity 3, which is opened to the surroundings to a side through a compensation opening 4. By way of the compensation opening 4 a connection to a mold cavity of a casting mold (not shown) is established. On the end arranged located opposite the compensation opening 4 a vent opening 5 is located. The diameter of the compensation opening 4 with the embodiment of the feeder shown is selected larger than the diameter of the vent opening 5, so that the feeder has a conical shape. However, it is also possible to design the diameter of the compensation opening 4 and the ventilation opening 5 equally, so that the feeder assumes the shape of a tube. The inner diameter of such a feeder can for example amount to 8 cm and the wall thickness of the feeder wall 3 cm with a height of the feeder of 15 cm.

A further embodiment of a feeder according to the invention is shown in FIG. 2. The feeder 6 comprises a compensation cavity 3, which is surrounded by the feeder wall 7, so that the compensation cavity 3 is closed off towards the top in order to reduce heat losses of the liquid aluminum. The feeder 6 is constructed in two parts and comprises a feeder base 8 as well as a feeder lid 9. Feeder base 8 and feeder lid 9 jointly form a feeder wall, which surrounds the compensation cavity 3. In the centre of the feeder lid 9 a clearance 10 for accommodating the tip of a spring mandrel 11 is provided. In the feeder base 8 a compensation opening 4 is provided, with which the connection from the compensation cavity 3 to a mold cavity of a casting mold which is not shown, is established. Both feeder base 8 as well as feeder lid 9 are produced from the molding material mixture according to the invention, which is characterized by a low content of oxidizable metal, an oxidizing agent employed sub-stoichiometrically compared with the quantity required for complete oxidation of the metal and by a high proportion of a fluorine-containing flux agent. The diameter of the feeder shown in FIG. 2 is approximately 15 cm at its widest point. The height amounts to approximately 20 cm. The wall thickness of the feeder lid 9 amounts to approximately 2 cm.

### Analysis Methods

Determining the specific surface area:

The BET-surface area is determined on a fully automatic nitrogen porosimeter made by Mikromeritics, type ASAP 2010, according to DIN 66131.

### Pore Volume

The pore volume is determined through mercury porosimetry according to DIN 66133.

Mean Particle Diameter (d₅₀)

The mean particle diameter was determined through laser difraction on a Mastersizer S, produced by Malvern Instruments GmbH, Herrenberg, DE according to the manufacturer's instructions.

### Elementary Analysis

The analysis is based on a total digestion of the materials. Following the dissolution of the solids the individual proportions are analyzed and quantified using conventional specific analysis methods such as for example ICP.

### Determination of the Bulk Density

The powdery porous fireproof material is filled in one operation into a previously weighed 1000 ml glass cylinder that has been cut off at the 1000 ml mark. Once the pouring cone has been wiped off and material adhering to the outside of the cylinder has been removed, the cylinder is weighed again. The weight increase corresponds to the density.

### Determination of the Gas Permeability

### a) Production of a Test Body

Approximately 100 g of the porous fireproof material to be tested, which has been set to an average grain of approximately 0.3 mm, is mixed in a mixer for the duration of approximately 2 minutes with 20 g of water glass (solid content approximately 30%, modulus SiO₂/Na₂O approximately 2.5). The mixture is filled into a sleeve having an inner diameter of 50 mm. The sleeve is inserted into a Georg-Fischer ram. The mixture is compacted in the ram through three impacts. The sleeve with the compacted molding compound is removed from the ram and the molding compound hardened in that from the open ends of the sleeve carbon dioxide is blown through the molding compound for approximately three seconds each. The hardened test body can then be pushed out of the sleeve. Once the test body has been pushed out its height is measured. This should amount to 50 mm. If the test body does not have the desired height a further test body has to be produced with an adjusted quantity of the molding compound. The test body is subsequently dried in an oven at 180° C. until the weight is constant.

### b) Testing the Gas Permeability

Testing of the gas permeability is carried out using a permeability testing apparatus type PDU by Georg-Fischer Aktiengesellschaft, 8201 Schaffhausen, Switzerland.

The test body produced as described in (a) is inserted in the precision test body tube of the apparatus and the gap between test body and test body tube sealed off. The test body tube is inserted in the testing apparatus and the gas permeability number Gd determined. The gas permeability number Gd indicates how many cm³ of air with a pressure of 1 cm water column pass through a cube or cylinder with 1 cm² cross section within a minute. The gas permeability number is calculated as follows:

Gd=(Q·h)/(F·p·t)

With the following meanings:

Gd: Gas permeability number

Q: Through-flowing air volume (2000 cm³);

h: Height of test body

F: Cross-sectional area of the test body (19.63 cm²);

p: Pressure in cm water column;

t: Throughflow time for 2000 cm³ of air in minutes.

p and t are determined: all other values are constants determined by the testing equipment.

### Example 1

Tubular feeders were produced from a molding material mixture of the following formulations:

TABLE 1
Formulation for producing feeders

| | Quantity |
|---|---|
| Proportion | employed |
| Aluminum grit | 15% by weight |
| Sodium hexafluoroaluminate | 7% by weight |
| Sodium nitrate | 13% by weight |
| Quartz sand | 50% by weight |
| Water glass** | 15% by weight |

**Solids content: 50% by weight, modulus: 2.2.

The molding material mixtures were shot into a shape at room temperature and hardened there for 90 seconds by passing through carbon dioxide. Following this, the feeder blanks were dried for five hours in an oven at 180° C. Tubular feeders with a length of 150 mm, an outer diameter of 59 mm and an inner diameter of 40 mm were obtained.

One of the feeders was ignited at its lower end in that it was briefly placed on a hot plate. Following the ignition, the feeder was placed on a clay slab. The oxidation front uniformly moved from the bottom up through the feeder. Once the oxidation front had migrated through the feeder, the temperature in the interior of the compensation cavity was determined at approximately 1150° C.

The feeders in each case are installed in a casting mold and an aluminum casting produced. As aluminum casting, a cube having an edge length of 15 cm was produced. Following the cooling down of the casting the casting mold was removed and the residual feeder knocked off. The fracture point was dressed through grinding. The casting was ex-rayed. During this, no shrink holes in the casting were determined. In addition, the infeed point on the casting was microscopically examined. No crystalline disorders or casting inclusions were detected.

1. An exothermic molding material mixture for producing feeders for casting aluminum, comprising:
a fireproof base molding material;
a binder;
based on the molding material mixture, a proportion of an oxidizable metal of 5 to 18% by weight;
an oxidizing agent in a proportion based on the quantity of the oxidizing agent required for the complete oxidation of the oxidizable metal of 10 to 50%; and
an igniter for the oxidation of the oxidizable metal in a proportion from 15 to 50% by weight, based on the quantity of the oxidizable metal.

2. The exothermic molding material mixture according to claim 1, wherein the igniter for the oxidation of the oxidizable metal is a fluorine-comprising flux agent.

3. The exothermic molding material mixture according to claim 1, wherein the igniter for the oxidation of the oxidizable metal is magnesium metal.

4. The exothermic molding material mixture of claim 1, wherein the oxidizable metal is selected from the group consisting of aluminum, magnesium and silicon, as well as their alloys.

5. The exothermic molding material mixture of claim 3, wherein the magnesium at least partially is present in the form of an alloy, preferentially an aluminum alloy.

6. The exothermic molding material mixture of claim 1, wherein the grain size of the oxidizable metal is selected greater than 0.05 μm.

7. The exothermic molding material mixture of claim 1, wherein the fireproof base molding material at least partially is formed by an insulating fireproof material.

8. The exothermic molding material mixture according to claim 7, wherein the insulating fireproof material has a bulk density of less than 0.5 kg/l.

9. The exothermic molding material mixture according to claim 7, wherein the insulating fireproof material is selected from the group consisting of pumice, foam lava, vermiculite, hollow aluminum silicate microspheres and porous glass spheres.

10. The exothermic molding material mixture of claim 7, wherein the proportion of the insulating fireproof material in the fireproof base molding material is selected greater than 20% by weight.

11. The exothermic molding material mixture of claim 1, wherein the proportion of the binder, calculated as solid and based on the molding material mixture is selected between 5 and 50% by weight.

12. The exothermic molding material mixture of claim 1, wherein the molding material mixture comprises a proportion of a combustible organic material.

13. An exothermic feeder for casting aluminum, produced from the exothermic molding material mixture of claim 1, which during burning-off reaches a temperature of less than 1250° C., with a compensation cavity and a feeder wall surrounding the compensation cavity, wherein the feeder wall comprises:
a fireproof base molding material;
a binder;
an oxidizable metal in a proportion from 5 to 18% by weight based on the weight of the feeder;
an oxidizing agent in a proportion based on the quantity of the oxidizing agent required for the complete oxidation of the oxidizable metal from 10 to 50%; and
an igniter for the oxidation of the oxidizable metal in a proportion based on the quantity of the oxidizable metal from 1 to 50% by weight.

14-15. (canceled)

16. A method for casting aluminum, comprising the steps of:
providing a casting mold having a mold cavity, the mold cavity comprising at least one feeder according to claim 13 with a compensation cavity;
filling the casting mold with liquid aluminum, such that the compensation cavity is filled with a feeder volume of the liquid aluminum;
sucking a quantity of the liquid aluminum amounting to at least 25% of the feeder volume from the compensation cavity into the mold cavity; and
allowing the liquid aluminum to solidify.
